(19) United States
(12) Patent Application Publication
(10) Pub. No.: US 2006/0244831 A1
(43) Pub. Date: Nov. 2, 2006

(54) System and method for supplying and receiving a custom image

(76) Inventors: Clifford H. Kraft, Naperville, IL (US); William L. Reber, Rolling Meadows, IL (US); Vasilios D. Dossas, Niles, IL (US)

Correspondence Address: Clifford Kraft, 320 Robin Hill Dr., Naperville, IL, 60540, US

(21) Appl. No.: 11/117,101

(22) Filed: Apr. 28, 2005

(51) Int. Cl. H04N 7/18; H04N 5/232

(52) U.S. Cl. 348/157; 348/211.11

(57) ABSTRACT

A system and method for supplying and receiving custom scenes of events like sporting events where a user can request a particular image, either one that is known to be available, or in some embodiments, an image from a virtual camera located anywhere the user wishes it and pointed in a direction specified by the user with a specified zoom. Parameters of some such virtual scenes can be predetermined for the user (such as the moving view from the kicker's eyes during a field goal kick). Requests can be made for images and images can be transmitted by any possible transmission method or technique including cable, internet, wireless and telephone. Images can be displayed on any type of wired, cabled, or wireless device. In particular, special eyeglasses or heads-up displays can be used. Displayed images can be 2-dimensional or 3-dimensional.

### BACKGROUND

1. Field of the Invention

The present invention relates generally to the field of supplying images and more particularly to a system and method for supplying and receiving a custom image.

2. Description of the Prior Art

It is well known to televise and photograph sporting events, parades and many other events. Live video, as well as still photos, are supplied to a vast audience of viewers both by Conventional television, and by a myriad of new technologies such as the internet and on the screen of a cellular telephone.

Normally, the images presented to the final viewer have characteristics and presentation that are determined at the time the photo is taken. For example, the angle, perspective, zoom level, contrast, color and many other picture characteristics are determined by the location, angle and settings of the camera. A camera situated on the 50 yard line of a football game cannot provide a view looking in on a field goal from behind the goal posts. That requires a second camera or movement of a first camera to a different position.

It is known in the art to photograph a scene with a camera containing a fisheye lens from a position above an event, and then to process the resulting image using signal processing techniques to produce any one of various flat (non-fisheye) images representing different angles and perspectives that could have been achieved by a normal lens at any rotation, tilt or zoom within the fisheye hemisphere. Zimmermann, in U.S. Pat. No. 5,185,667 teaches the mathematical transformation needed to accomplish this. U.S. Pat. No. 5,185,667 is hereby incorporated by reference. Zimmermann's technique is limited to views that could have been produced by a normal (flat) lens at the same position.

It would be advantageous to have a system and method for supplying ready-made, on-demand images of an event directly to a viewer, where the image parameters such as angle, zoom, perspective and others are under direct and continuous control of the user.

### SUMMARY OF THE INVENTION

The present invention relates to a system and method for supplying custom images of an event where users can request different custom images and can control and change the generation of those images. At least one camera can be positioned near an event with camera producing image data. Preferably several cameras cover an event possibly in stereographic (or polygraphic) pairs or groups. Image data from these cameras can be used to reconstruct images for users from different real and virtual camera locations and directions of view. A processor can receive custom image demands from viewers, where each of the image demands specifies parameters for a particular requested image such as desired image camera location, direction of view and zoom. Normally one or more processors can process raw input data to create time-changing, real-time 2- or 3-dimensional models of the scene that can subsequently be used to re-create custom 2- or 3-dimensional images. While stereoscopic coverage is preferred, any camera arrangement is within the scope of the present invention. Image requests and supplied images can be transmitted and received by any transmission method on any type of receiving device. Transmission methods can be wire, wireless, light, cable, fiber optics or any other transmission method. Devices can be any device capable of displaying an image including TVs, PCs, laptops, PDAs, cellular telephones, heads-up displays and any other device. Users can interface with the system by any data communications method including cable, telephone, wireless, internet or by any other method. Displays can be 2-dimensional or 3-dimensional.

### DESCRIPTION OF THE FIGURES

FIG. 1 shows a stadium with several cameras positioned near an event.

FIG. 2 shows a user's screen with a moving view of a field goal kick.

FIG. 3 shows an overview block diagram of an embodiment of the present invention.

FIG. 4 shows an overview block diagram of an embodiment of camera signal processing.

FIG. 5 displays the Zimmermann Pan/Tilt/Zoom Equations.

FIGS. 6A-6B show an example of a left and right stereoscopic image without highlights.

FIGS. 7A-7B show the same stereoscopic image as that of FIG. 6 with specular highlights.

FIG. 8 displays the Devernay-Faugeras reconstruction function.

FIG. 9 shows derivatives of the reconstruction function.

FIG. 10 shows a technique for finding derivatives of the disparity map.

FIG. 11 displays Devernay-Faugeras surface derivatives.

FIG. 12 shows a signal processing flow chart.

FIG. 13 shows a depiction of a wireless user imaging device

FIG. 14 shows a block diagram of an image distribution center.

FIG. 15 is a block diagram of possible signal processing hardware.

FIG. 16 shows a flowchart of a possible business model of the present invention.

### DESCRIPTION OF THE INVENTION

The present invention relates to a system and method of supplying on-demand, custom images to viewers of an event by using one or more cameras positioned around and/or above the event. This camera(s) can generally supply continuous video feed or fixed frame images through a signal processor to a plurality of users, where each user can choose the angle of view, zoom and other parameters of the view that viewer is watching. Each different viewer can adjust his own image to be what he or she wants at that particular instant. Multiple images with different camera positions, angles of view, zooms and other parameters can be displayed to a user simultaneously. The viewer can also be supplied with a set of pre-determined or pre-setup views that might cover a particular situation (such as a set of views for a field goal kick, kickoff, parade, etc.). The user may optionally control watched images with a control device such as a joystick or dedicated key pads or from the control of a wireless device like a cellular telephone, wireless controller or any other remote control method.

In one embodiment of the present invention, the user could only pick possible views from any of the possible pan, tilt and zoom views from cameras actually covering the event. In another embodiment of the present invention, the use could choose possible views from almost any virtual camera location and direction of view with any desired zoom. It is desirable to use cameras with fisheye lenses or other wide-angle lenses that provide mathematical pan, tilt and zoom with no moving parts. It is also advantageous to use groups of two or more cameras at each camera location or various camera locations. This allows stereoscopic image reconstruction of 3-dimensional features of images. While the preferred method is to have pairs of cameras with wide-angle or fisheye lenses, this is optional. Any arrangement or positioning of cameras is within the scope of the present invention. Any combination of single cameras with camera pairs and fisheye lenses with standard lenses is within the scope of the present invention.

### Specific Example of One Embodiment

In order to aid in the understanding of the present invention, a specific example of one embodiment is described. Numerous other examples and embodiments with various combinations of features are within the scope of the present invention.

In this example, it will be assumed that the present invention will be used to provide custom images of a football game. To provide arbitrary images, cameras must be placed around the field. In this example, cameras with 20 mm wide angle lenses will be place around the playing field and over it. The cameras will be placed in stereoscopic pairs. Ten pairs of NTSC output broadcast video cameras will be located around the oval of the stadium at a height of 20 feet above the field. Ten more identical pairs will be placed around the field at a height of 50 feet above field level. In addition, two camera pairs will be mounted on 150 foot towers at each end of the field, a camera pair will be mounted atop the press box, a camera pair will be attached to a tethered balloon across from the press box at approximately the same height as the press box, and a camera pair will be attached to the bottom of the Goodyear Blimp which will hover over the field during most of the game. Each camera in a particular camera pair will be separated from its mate by six feet.

All mounted cameras will feed standard NTSC video via dedicated coaxial cable to a control room located below the press box. The balloon and blimp cameras will feed video by x-band microwave link to microwave receiving antennas located on the top of the press box. From there, the signal will travel via dedicated coaxial cable to the control room.

In the control room, each separate video feed will be digitized into 20 MHz digital feeds of 24 bit color words that are framed at the original NTSC frame rate of 30 frames per second. The digital data rate will be 500 MBit/Sec to include control bits. Digital frames from the two members of a camera pair will be processed together in subsequent steps. The digital feeds will be stored in real-time in a digital frame buffer memory queue.

Each related pair of frame buffer queues will be read by a dedicated digital signal processor group that will perform a transformation on the image data that is called the Zimmerman Transformation that will later be described in detail. This transformation causes each video frame image from the wide angle lenses to be expanded into a large set of different images, each with a different pan and tilt angle. In the present example, each wide angle frame will create 200 different flat frame images, each at different pan and tilt. The zoom setting on the balloon and blimp feeds will be increased to equal that of the field cameras.

In this example, each signal processor group will feed 400 output frame buffer queues (that is 200 different stereoscopic views). These frame buffer queues will be read by a bank of stereoscopic image processors arranged in a massively parallel array that will feed into a second level of image processors that will construct a real-time 3-dimensional image coordinate space of the entire playing field that is updated every 1/30 of a second. This continually updated, 3-dimensional representation of the entire game, crowd and field area will be stored in a 3-dimensional image storage memory bank. In the present example, several of these banks can be used to provide a sequential time memory of the last N seconds or minutes of the game (such as the last 2 minutes).

An image request processor will independently read the 3-dimensional image memory bank as needed to provide custom 2-dimensional color video feed for particular image demands from subscribers. These will be 2-dimensional projections of the 3-dimensional image using standard digital projection techniques. In some cases, missing coverage or colors can be simulated by the system.

Image requests can enter the control room and into an image request server via normal POTS telephone service, internet, cable or by any other means. One example might be a fan in the stands who phones in an image request from his or her cellular telephone. The request might be a view from 40 feet above the 50 yard line, or it might be a request to always look parallel to the line of scrimmage. Special canned view locations might also be available for users such as the view from the kicker's eyes during kick-offs and field-goals. The user could flip from his normal view to the special view, and back, via on of the keys on his phone. Using this example of the present invention, the user, who could only get a seat in the end-zone can now also see the game from any vantage point he wishes. Other users could control the system from set-top boxes with joy sticks, keys or other means. The user of the present invention becomes the director.

As images enter the image server in the present example, they are processed and assigned an image projection processor. This processor accesses the 3-dimensional image memory bank as needed to produce a 2-dimensional color video output stream that is fed to a stream distribution frame. Here the image stream is recoded into a proper form and data rate for the user's receiver. In the present example, the user with the cellular telephone may be able to receive at live video speed from the cellular provider. The distribution frame can recode the data to match the required format of the cellular provider (or internet streaming, etc.). The live image stream is fed out to the user via the cellular downlink, while any new image commands are fed from the user on the uplink. The user could be charged a one-time fee for the service, a per-time-used fee, a monthly subscription fee, or be billed by any other method.

Other Features

While the present invention generally allows a user to command custom views on a particular viewing device, it also contains features that help the user in choosing that view. In some embodiments, the user can be presented with an overview of the viewing field with an indicator such as a frame box that could be moved over the desired viewing area. The touch of a button or other command could then allow the custom image to replace or displace the overview. Alternatively, an overview could be presented in the form of a small guide frame that shows where the custom view is being generated or in the form of thumbnail sketches known in the art. Users can “push to navigate” and/or “push to view” different points of views or custom images by simply manipulating buttons or keys on a display device like a cellular telephone or control for a television. Users could have certain “hot buttons” to select or return to various special viewpoints or images. Users could also use other buttons or controls to “snap” still shots and save them (or transmit them) from the live scene.

In the business model of the present invention, different ads or advertising could be related to different custom views. In some views, advertising could be artificially “hung” around a playing field or presented in any other manner. Alternatively, advertising could be custom with a particular image and appear in a separate image box adjacent or near the main image.

General Description

Generally the system of the present invention can be realized using massively parallel signal processor chips or other parallel processors (or a single fast processor). Parallel input streams from different cameras can be digitized and fed directly to particular banks of signal processors. Other single or parallel processors can control the generation of custom images. Images can be fed to viewers via cable, internet, telephone or by any other communication method. Signals from viewers can be received over the internet, by telephone, cable or by any other means and fed to the control processors.

Raw signals from the camera(s) can be fed by any means known in the art such as cable, RF, fiber optics, etc. to one or more combining or processing locations. At this point in the system, processors using signal processing techniques can produce custom images to be fed or streamed directly to users. These custom images can be demanded interactively by users. Users can access the system via their television sets, over the internet, from portable communication devices like cellular telephones, or by any other method of receiving a custom image including a heads-up image supplied to special user screens such as glasses.

Each viewer can enter commands as to what image or images he wishes to see. These commands can be used interactively to change the image parameters on demand. A particular viewer may wish to see more than one image simultaneously. For example, a viewer may wish to simultaneously see a split-screen view of a field goal kick from 1) the view the kicker sees, 2) the view toward the kicker from behind the goal posts, and 2) a view from above. After the play is finished, the viewer may want to return to a full field view. The parameter setup for such standard custom images may be pre-programmed and available to the user using a single command or button push. A particular user's screen setup is shown in FIG. 2. Here, the screen is split two ways. The user observing the screen in FIG. 2 could immediately change back to a normal view after the kick.

Supplying adaptive views of an event on demand can be provided by a subscription service where views pay monthly or one-time fees for the extra service. Local processing could also optionally be provided by a set-top box or integrated module in the case of television. For a cellular telephone, a viewer could simply call a particular telephone number, enter an access code, and demand a particular view of a particular event. Access could include using speech recognition or intelligent voice response systems.

Camera Positioning

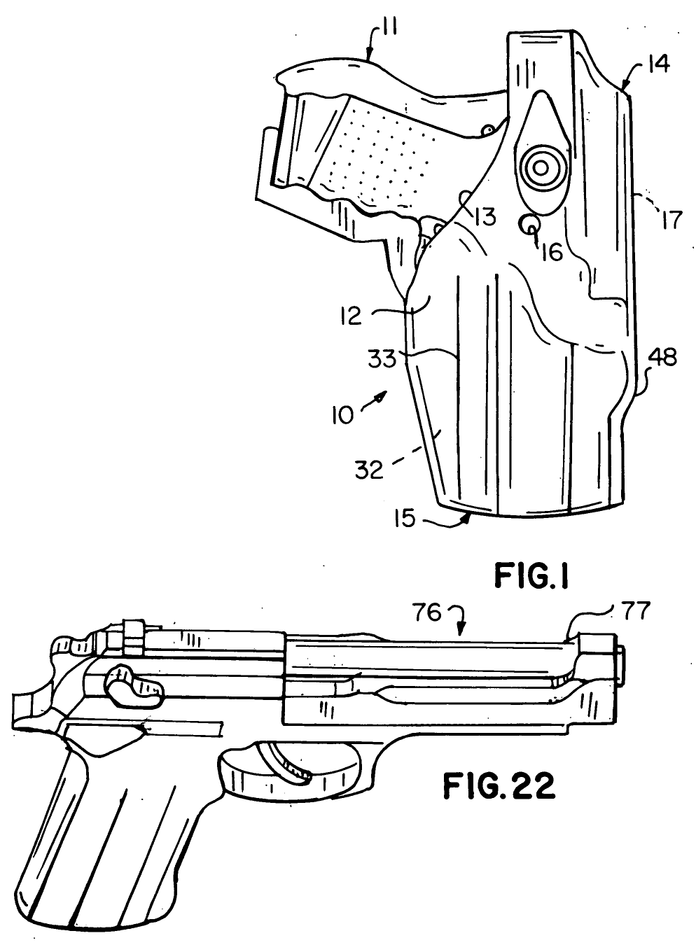

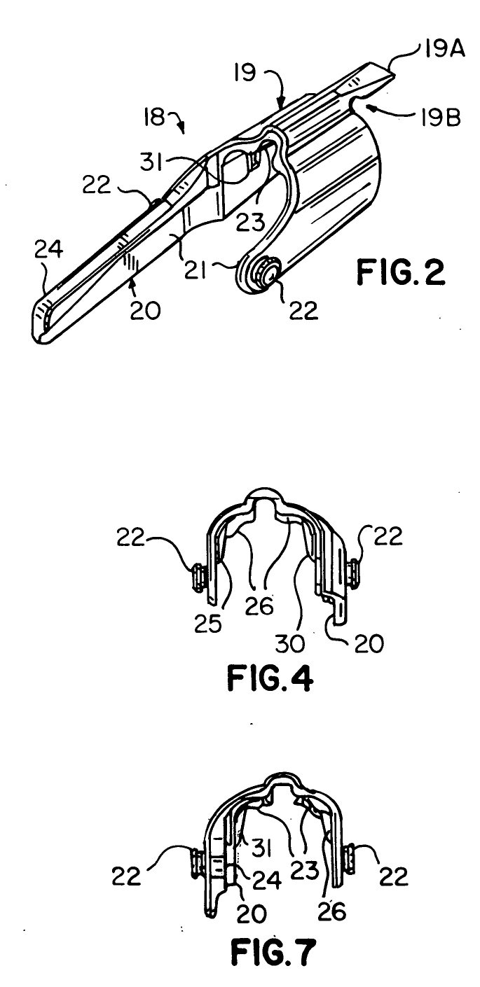

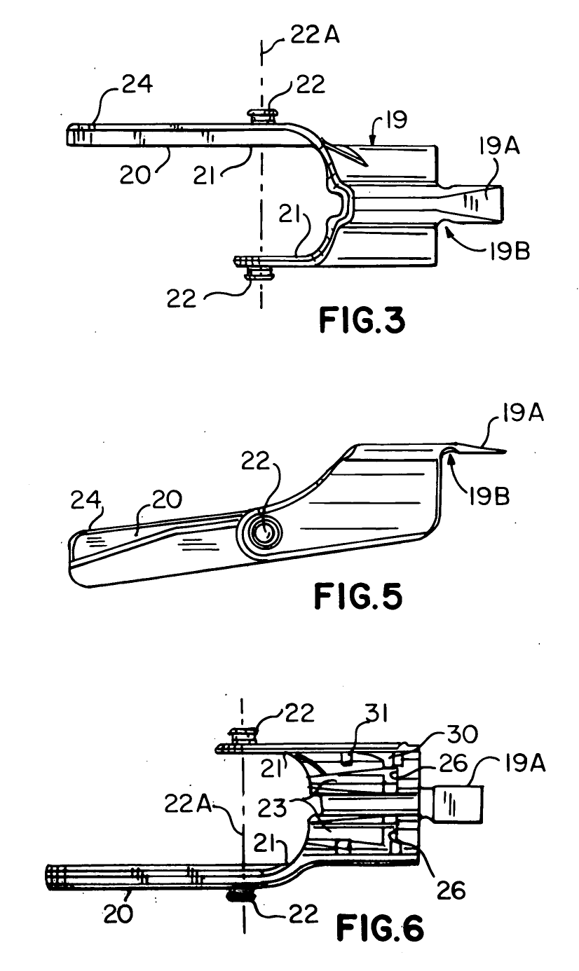

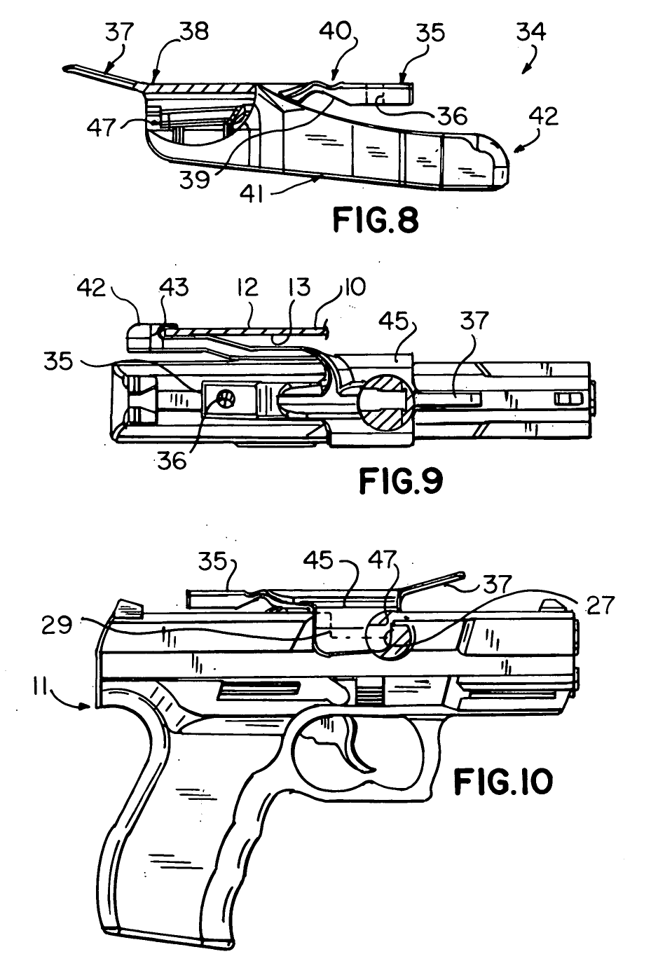

In order to provide the raw data for signal processing of custom images for viewers, a camera or multiple cameras can be positioned above and/or around an event and, optionally, at the level of the event(or slightly elevated for convenience or to avoid obstacles). Above does not necessarily have to mean directly above any particular position, but rather generally elevated with respect to the plane of the event. Turning to FIG. 1, a possible camera positioning is shown for a stadium 1 where an event 2 takes place. Cameras 3 can be seen located on towers 4 at the top of the stadium, around its rim, and around the field. In addition cameras 7, 9 can be seen on a balloon 6 and on a blimp 8 above the playing field 2. Different types of events may require cameras at different positions. In particular, an event that does not take place on a horizontal plane (such as a motorcycle race up a hill for example) might require different camera placement. The present invention can function with only one camera; however, it is preferred to have multiple cameras to improve the variety of the number of computed views that can be produced. The cameras can be special cameras that are used to augment normal TV broadcasting including high-definition cameras, or they can replace normal TV cameras.

Each positioned camera, of course, is normally equipped with a lens. While the preferred lens is a fisheye lens or other wide-angle lens, any other lens can be used. Mathematical transformations can be used to combine images from any or all cameras covering an event to produce virtual pan, tilt and zoom and to create virtual camera positions and view angles from many different virtual locations.

In some embodiments of the present invention, a camera 7 or cameras might be placed on a controllable balloon 6 that could be steered to different positions above the event. These embodiments are particularly useful for covering events like parades where the action may move or be spread out over a large physical area. This type of camera positioning can also be advantageous for covering news events (for example a burning building) and for security monitoring. Such a balloon containing preferably a camera with a fisheye lens could be launched on short notice and immediately begin to provide feed from a safe position near the scene, but possibly not directly above it (for safety reasons). A tethered or un-tethered balloon is also very useful for security applications of the present invention such as watching a crowd or parking lot.

While single cameras can be used to produce many different types of virtual images for the viewer, the preferred method is for many of the cameras to be placed in stereoscopic pairs of known or even calibrated distance apart. This is because with stereoscopic cameras, 3-dimensional reconstruction of image data can be made using mathematical transformations. 3-dimensional image reconstruction allows many more possible virtual views than a construction based on isolated cameras. Pairs of stereoscopic cameras equipped with fisheye lenses can be virtually panned, tilted and zoomed across an image to produce numerous stereoscopic viewpoints that can be further transformed into 3-dimensional surface data. With fisheye lenses, this can be done with no moving parts and no mechanical delay times.

The present invention is useful to produce arbitrary virtual views that can be demanded from users either by direct view parameters or by types of views. Direct view parameters can generally specify the position of a virtual camera, its direction of view, its up direction, and its magnification or zoom (other parameters could be its perspective, depth of field, f-stop, pan rate, tilt rate, zoom rate and many others). Types of views can be pre-designed to cover certain frequently occurring situations. FIG. 2, for example, shows a dynamic custom view from a virtual camera that approximately tracks the eyes of a field goal kicker in an American football game. The scene starts with the direction of view generally toward the line back who will hold the ball. The ball is snapped and placed into position (as in FIG. 2). The field goal kicker runs toward the ball. The scene moves dynamically with the kicker. The direction of view points to the ball. As the kick is made, the direction of view changes up to the goal posts, and the flight of the ball is followed, again as the kicker would see it. To produce such a custom sequence, complete scene reconstruction from all cameras covering the field can be used as well as dynamic or manual control over the instantaneous location of the virtual camera and its direction of view vector. An optional extra effect of zooming slightly when following the ball in flight could add to the excitement of the viewer.

### System Overview

General System Design

Turning to FIG. 3, a block diagram of an embodiment of the present invention is seen. Cameras are normally located around an event. Some of these can have hardwire feeds, while others can have wireless feeds. Any type of feed is within the scope of the present invention. Cameras can generally be fed to a set of signal conditioning circuits which can contain A/D converters, amplifiers and other signal conditioning equipment. Cameras can be TV, CCD, Still, or any other type of cameras. Feeds can be standard video (such as NTSC or PAL) or they can be red/green/blue or any other color base or image combination (including still images). Feeds can be analog or digital. The optional signal conditioning generally produces sequences of stereoscopic, polyscopic or monoscopic images in a form that can be processed to perform either partial or total scene reconstruction. In addition, images can be piped directly to users without any reconstruction.

As seen in FIG. 3, partially or totally reconstructed scenes can be stored in a real-time storage or queuing medium. This can be used both for real-time feed to image generators and for short or long term storage for replay. Any type of fast storage can be used. The preferred storage is fast random access memory devices RAM. Slower memory such as disks can be used for replays or playbacks. Generally reconstructed scenes can contain 3-dimensional coordinates of scene points along with surface color for each point. Locations of scene lighting and other scene parameters can also be stored.

Output from a scene storage array or queue can be fed to custom image generators that attempt to recreate a custom view from a virtual camera with a specified direction or angle of view and zoom on user demand. User demands come in as image requests that are decoded and used to control each image generator module. Generated images can be fed back to users through various media such as cable, internet streaming, wireless and by any other method of supplying an image to a user who can receive it and display it. In addition to generating custom images, image generators can also simply pipe real images from any cameras covering the event including any standard commercial broadcast cameras. User requests can come in by internet, telephone, wireless, hardwire, WIFI, or by any other method of receiving a request for an image.

Signal Processing

Signal processing generally consists of several separate portions: virtual pan, tilt and zoom; image object reconstruction; and virtual view synthesis. Virtual pan, tilt and zoom can be accomplished by use of the Zimmermann transformation that takes the hemispherical full image of a fisheye lens and produces a flat projected image in any viewing plane that a normal lens could produce from the same camera position. Image object reconstruction can try to produce 3-dimensional surface information about the objects in the event field or assign properties to image points. Virtual view synthesis produces a view and perspective from a virtual camera located at a specified position and pointing in a specified direction (with a particular perspective and zoom).

In general, there are several ways to create an arbitrary image from a virtual camera position by combining images from real camera positions: Stereographic combination, 3-dimensional reconstruction, surface point ray tracing, 3-dimensional animation modeling aided by real-time update and many others. Any method of producing a virtual image from real camera data is within the scope of the present invention.

Stereographic combination duplicates the processing that takes place inside a human brain where two separate images are simultaneously processed (one from each eye) to produce a central image. The brain processing results in depth perception as well as image production. The present invention can make use of similar processing techniques to produce a resulting central flat image. One method of doing this makes use of a neural network that attempts to simulate brain signal processing. Stereographic data can also be used to produce a 3-dimensional model of the event field.

3-dimensional reconstruction uses two or more cameras located stereoscopically or possibly three orthogonal locations. Sometimes the cameras move or pan through the scene. The processor attempts to re-create mathematically the 3-dimensional objects in the field of view of all the cameras. This technique encounters difficulties with hidden lines and surfaces. However, with enough cameras or virtual panning, tilting and zooming using the Zimmermann equations, good approximations can be made to hidden structures. 3-dimensional reconstruction generally tries to compute the coordinates and color properties of each surface point in the event field (or at least a subset of important points).

Surface point ray tracing tries to compute the diffuse light component scattered from each point on a 3-dimensional surface. To do this, the processor must know the approximate location of light sources (or assume a universal ambient light source) and approximate the normal vector at each point on the surface. This technique does not allow the reconstruction of specular reflections (highlights) since to reconstruct a highlight requires not only the surface normal and spot location of the light source, but also the material properties of the surface (shininess parameter). While the present invention includes specular computations, embodiments omitting them do not face a serious drawback because a typical viewer (like a football fan) is not usually interested in the specular highlight on an object like a football helmet; the fan is interested in what color the jersey is, what the player's number is, and what team insignia is on the uniform and helmet. Fine details such as facial features also cannot be seen in many views, and may be of no interest in these views. In this technique, ray tracing can be used (or at least some sort of depth buffer ordering) to block rays (and prevent computation) from objects that are behind other objects in the virtual field of view. This technique can be combined with 3-dimensional object reconstruction to produce a final virtual image.

Animation modeling involves modeling of a known outline without fine details in an animated format. For example, a model animated player can be pre-computed and such details as the shape and size of a person, jersey color and number, helmet insignia can be added. The “model” player (or animated player) can then be made to run, fall, catch passes, etc. through known animation techniques driven in real time by what the real cameras are viewing. In the present invention, the animated technique can be combined with other techniques to “fill-in” missing information, especially details that may be in the background of scenes.

Some embodiments of the present invention try to produce any image desired by the viewer—that is an image from any possible virtual or real camera location at any pointing angle, while other embodiments only produce images possible from real cameras, for example, images from any possible pan, tilt or zoom setting at the center of a fisheye lens. Many embodiments of the present invention combine the techniques described.

Because many of these techniques can be compute-intensive, considerable processor power may be needed to produce real-time virtual images. Any signal processing technique is within the scope of the present invention including, but not limited to, pipelining, array processing, distributed processing and massively parallel computing. Simple virtual pan, tilt and zoom does not require as much computation as 3-dimensional object reconstruction. Therefore, some views are computationally less demanding than others depending on camera positioning. In some embodiments of the present invention, computing demand can be reduced by supplying standard views from a simple mathematical pan, tilt and zoom of a single fisheye camera, and then possibly supplying more complex views on demand or in special cases. It is envisioned that computer power will only increase in the future; therefore, generally the mathematical techniques of the present invention can be implemented to produce any arbitrary view to any user in real-time, especially using parallel processors. FIG. 4 shows an overview block diagram of an embodiment of signal processing.

Groups of stereoscopic (or polyscopic) cameras can be used to view a scene. The preferred method uses pairs of cameras that are co-located and separated by a calibrated distance from one-other. Feed from the cameras (shown as red-green-blue in FIG. 4) can enter analog to digital converters (A/D) and be converted to digital words. Usually, the output is a single color-coded digital word for each scan point. Resolution can depend on A/D conversion speed as well as basic camera resolution. A/D conversion can be controlled by a master timing system that controls and synchronizes all system actions.

If a particular camera group is equipped with fish eye lenses, it is possible to mathematically perform arbitrary pan, tilt and zoom operations with no moving parts as described in the next section. For stereoscopic image reconstruction, zoom can usually be held constant, while pan and tilt can be caused to scan the entire scene. Pan/tilt scanning speed and image frame rate normally determine system resolution (along with the basic resolution of the optical systems). Because pan/tilt is a mathematical function (rather than a mechanical one), the scan can be in any order and does not have to be linear. Maximum resolution can be achieved with sufficient computer power. Pan/tilt scanning can be used to produce pairs of stereoscopic images that cover a wide field with each set slightly overlapping the previous set so that later processing can correlate the entire scene.

Stereo image reconstruction attempts to partially re-create the 3-dimensional points present (viewable) in a scene by providing the location, normal vector and principal curvatures at each point. Partial scene reconstruction as shown in FIG. 4 takes stereo image information and tries to create a 3-dimensional model of the scene in real time as will be explained. Partial scenes can be added together in a total scene reconstruction that combines and matches points from many different camera groups. Total scenes at a real time frame rate can be queued or stored in temporary or longer term fast storage. As previously stated, this can be fast RAM memory or longer term storage such as disk. 3-dimensional image data can be supplied on demand from the scene storage in a manner similar to that by which data is supplied from a database on request. If a scene generator needs a particular part of a scene, it is only necessary to supply data on the major point set viewable from the real or virtual camera position requested in the requested direction of view (also considering requested zoom). As with all parts of the system, these separate functions can be synchronous in time controlled by a master timing module or optionally some of them can be asynchronous. In particular, requests from image generators do not have to be synchronized with input image data (however, they can be).

A. Virtual Pan, Tilt and Zoom

Zimmermann derived a transformation that allows an image gathered on a flat plane from a 180 degree hemisphere fisheye lens to be transformed to a normal flat image (one that would be produced by a normal lens at the camera position) of any pan or tilt angle in the hemisphere and at any magnification (zoom). The Zimmermann equations are displayed in FIG. 5. (See U.S. Pat. No. 5,185,667 at col. 7, lines 30-54). In these equations, R is the radius of the image circle. This is the hemisphere upon which the image seems to be focused (this corresponds to the image plane of a flat image). The image circle is an imaginary hemisphere in front of the lens where an eye looking out of the lens (without depth perception) would think the image is painted. The parameter m is normally positive and is the magnification or zoom (a value of 1.0 is no zoom, and a value less than one would make the image smaller). The zenith angle corresponds to tilt, and the azimuth angle corresponds to pan. The object plane rotation angle allows the transformation to rotate the image so the “up” in the generated image can be placed in any direction. The coordinates x and y are coordinates in the plane located behind the hemisphere (flat plane behind the fisheye camera) where the fisheye distorted image is focused. These can be thought of as “film” coordinates on the film image focused by the fisheye lens. x and y can be chosen arbitrarily, but they must be orthogonal. Usually they are chosen to produce a right-handed Cartesian coordinate system. The related spherical coordinate system that contains the zenith and azimuth angles is also right handed with the zenith angle (pan) being measured from the x axis. u and v are the object plane coordinates, or the so-called camera coordinates, in the transformed flat panned, tilted and zoomed image. Either +v or −v is usually chosen to be “up” in the final generated image.

To produce a particular flat image from a fisheye image, u and v are allowed to roam throughout the desired flat image space of the panned, tilted and zoomed location with the Zimmermann equations (FIG. 5) yielding the corresponding data point in x,y or “film” coordinates on the fisheye image. The color value at x,y becomes the color value at u,v in the new generated image.

Because the Zimmermann equations are simple algebraic equations involving at most squares, square roots and trigonometric functions, they can be computed very rapidly by a signal processor. Thus, it is possible to compute thousands of scanned flat images for each fisheye image. Using a real-time video feed from a pair of co-located fisheye cameras, a Zimmermann equation processor can provide thousands of scanned stereoscopic flat image pairs per second of a 3-dimensional scene. These are computed as though a pair of cameras with mechanical pan and tilt were scanning the image at very high rate. However, since there is no mechanical motion whatsoever, the number of images per second totally determined in the present invention by the speed of the Zimmermann signal processor and the time for a video camera to scan a full frame. The effective pan and tilt speed can be millions of times faster than any mechanical system could produce. A typical video camera scans a full vertical frame in 1/30 of a second (in the U.S.). Thus a system that produced 1000 stereoscopic pairs per vertical frame scan must be able to solve the Zimmermann equations in 33 uS (time for one of the camera processors). Given a processor on each camera, this would result in 30,000 pairs of images per second.

While the use of the Zimmermann equations is the preferred method of producing panned, tilted and zoomed images in the present invention, any method of panning, tilting and zooming or otherwise really or virtually moving a camera or scanning an image is within the scope of the present invention.

Stereoscopic Offset

3-dimensional object reconstruction from stereoscopic images generally requires that each stereoscopic lens be approximately equidistant from the object point. Using the Zimmermann scanning method just described, this condition does not hold at many angles (angles leaning in the direction of the centerline between the cameras result in different path lengths to some objects). In these cases, the distance from one camera can be several feet different than the distance from the other camera (depending on the camera separation). Using the Zimmermann equations, the parameter m (zoom) can be adjusted differently for the two cameras in a pair to compensate. This difference in m value between the two cameras needed for stereoscopic correction is a simple function of the camera offset and the two angles.
Δm=Sin(β)Cos(α)
This formula assumes that the zenith angle β (tilt) is measured from the camera's central axis (which is the same for both cameras in a stereoscopic pair—the central direction of look), and that the azimuth angle α (pan) is measured from the line connecting the two cameras (an epipolar line). Thus looking straight out of the cameras, there is no correction; looking at a high tilt angle but perpendicular to the connecting line, there is no correction; but looking with high tilt along the common line (no pan) requires maximum correction.
B. Image Object Reconstruction

In stereoscopic imaging, there are two possible problems that can be solved: the first is finding a simple flat interpolation view located between the two cameras in the same plane; the second is attempting to find the actual surface properties of 3-dimensional objects in the scene. The first problem requires simply finding a central (or offset) projection matrix P′ given left and right projection matrices P and Q. this problem is very similar to finding disparity as will be described. The second problem is considerably more difficult than the first and can be solved by finding the 3-dimensional location of each point in a scene, as well as the normal vector and the principle curvatures at the point. Since this must be done for many points of interest, it can be particularly compute-intensive.

A pair of stereoscopic views of the same object is shown in FIGS. 6A-6B. Here a rectangular slab was photographed by a left camera and a right camera. If the axis generally facing the viewer is considered the x-axis, and the axis pointing toward the right is considered the y-axis with up being the z-axis, the camera position for the left view is at (x,y,z)=(30,5,10) and for the right hand view is at (30,10,5). The cameras are 5 axis units apart on a line parallel to the y-axis at a distance in x of 30 units. The cameras are also elevated 10 units above the xy plane but are pointing toward the origin (which is the location of one corner of the slab). The simple problem mentioned above would be to interpolate to form the view half way between the cameras. This can be done relatively simply by known techniques. The generated, or virtual view, would be from an identical camera located at the point (30,7.5,10) also looking at the origin. The complex problem discussed above would be to find the surface normal and principal curvatures at each surface point visible (or at least those points visible to both of the cameras). For this particular simple object, all the front normals are aligned with the x-axis, all of the top normals are aligned with the z-axis, and all of the right side normals are aligned with the y-axis; the curvatures are all zero (actually the edge curvatures are infinite; however, it is customary to ignore them and use special techniques to represent sharp edges and corners).

The views in FIGS. 6A-6B are the result of mostly diffuse light. There are positioned lights behind the camera which result in the different shading of the respective surfaces. FIGS. 7A-7B show the identical scene with a specular highlight (the white area on the front of the object that gets lighter toward the origin). This highlight is the result of the object being shinny. Techniques that only find surface normals and curvatures cannot reproduce highlights in a constructed image scene because the nature of the highlight depends on the smoothness of the surface (reflectivity) as well the position of the light and the virtual position of the camera with respect to the direct reflection angle. In the present invention, image interpolation or other techniques can be used to interpolate highlights. Accurate specular reproduction in arbitrary image locations may require considerably more cameras as well as ways to determine the shininess at each point as well as light source locations. Fortunately, this type of highlight information is not usually needed for event coverage such as provided by the present invention and can be mostly ignored in image reproduction. Nevertheless, specular reproduction can be accomplished by using special layers in a 3-dimensional scene model that approximates surface shineness and keeps track of where specular light sources are located (such as the sun and spotlights).

It is known in the art that the color of a given point in a scene on a diffuse (or Lambertian) surface is independent of the view angle (as opposed to a specular highlight). The diffuse color depends only on the original color of the light shining on the surface, the color absorption of the surface and the cosine of the angle between the surface normal and a vector pointing toward the light source (in a simplified physical model). Thus, the for a stereoscopic 3-dimensional reconstruction, a given point can be assigned a fixed color which can be the average of the colors of two original images (in some appropriate color coordinate system). A more advanced model can attempt to remove specular highlights from scenes to provide more accurate diffuse colors. However, this requires global computations on an object to accurately estimate the specular component. In general, this is not necessary. While the preferred method is to simply use the color average between the two stereoscopic images, any method of estimated the color of a point is within the scope of the present invention.

In 1994, Devernay and Faugeras presented a method of finding surface normals and principal curvatures on 3-dimensional surfaces from pairs of stereoscopic images. There results are shown in condensed form in FIGS. 8-11 and can generally be called the Devernay/Faugeras equations (See, Devernay and Faugeras, “Computing Differential Properties of 3-D Shapes from Stereoscopic Images without 3-D Models”, presented at INRIA in Paris, July 1994, paper no. 2304). The method estimates the disparity between the images and its derivatives directly from the image data itself. These derivatives are then related to the surface differential properties at each point of interest.

1. Differential Surface Properties

If (λ₁, μ₁)represents 2-dimensional image coordinates in a left stereoscopic image, and (λ₂, μ₂)represents 2-dimensional image coordinates in a corresponding right stereoscopic image, a point M(x,y,z) on an object surface in the scene appearing in both cameras can be represented as m₁(λ₁, μ₁)in the left image and m₂(λ₂, μ₂)in the right image for some sets of particular coordinate values. Assume there is a reconstruction function:
M(x,y,z)=r(λ₁, μ₁, λ₂, μ₂)
that when applied to the left and right image coordinates of ml and m₂ yields M (Note: these are not the same x and y values referred to in the Zimmermann equations). Also assume there is a left/right relation function:
(λ₂, μ₂)=f(λ₁, μ₁)
such that when the point M is viewed by the left camera to produce the point m₁ in the left image and by the right camera to produce the point m₂ in the right image, the two image points are related by f.

Devernay and Faugeras derive such a functions when the scene is oriented in what are called standard coordinates (horizontal in the images is the same as the line connecting the cameras—epipolar lines are horizontal). If the projection matrices of the left image and right images respectively are P and Q, the reconstruction function is of the form:
μ₁=μ₂
r(λ₁, μ₁, λ₂)=A⁻¹B
where the exact form of the reconstruction function r and the matrices A and B are given in FIG. 8.

In order to find the differential surface properties of the point M(x,y,z)such as the normal direction and curvature at M on the surface, classical techniques known in intrinsic and extrinsic surface geometry of embedded surfaces can be used. This requires expressions for dr and d(dr). These differentials are expressed in FIG. 9 in terms of the Jacobian of the reconstruction and its first derivative.

The relation function f between the left and right images. can be expressed in standard coordinates as: λ₂=f(λ₁, μ₁). This function can be computed by simple geometry in epipolar coordinates using the disparity map. Again Devernay and Faugeras present techniques for this in the cited reference using one image as a reference for the other. They also discuss how to find the partial derivatives of the function f with respect to its arguments. Typically, the disparity function is computed by classical correlation techniques. Partial derivatives of f with respect to the various coordinates can also be computed. FIG. 10 shows an example of considerations for finding derivatives (differentials) using the disparity DIS.

Generally, the input to the computing engine is a left and right image. The cameras can be calibrated (and corrected) so that an image pair can be presented where the camera axes are parallel, and the cameras are displaced only along (local) horizontal image plane coordinates to obtain a result where epipolar lines are horizontal. The disparity map DIS can be obtained by first finding a candidate point in the left image and then performing a horizontal search along the same epipolar line in the right image for the corresponding point. The most probable match point in the right image is chosen, and the corresponding disparity is computed. The search is repeated for each pixel in the left image. (See, e.g., R. Koch, “Automatic Reconstruction of Buildings from Stereoscopic Image Sequences”, Institut für Theoretische Nachrichtentechik und Informationsverarbeitung, Universität Hannover,EUROGRAPHICS, '93, Barcelona, Spain September 1993).

FIG. 11 shows the Devernay and Faugeras equations for dM and d(dM)that can be used to find the normal direction and the principal curvatures of a scene surface at a particular point M(x,y,z). Vectors in the tangent plane at M (the plane perpindicular to the normal) are can be formulated as special cases of the Jacobian of the reconstruction function r mapping and derivatives of the relation function f. The derivation of Devernay and Faugeras is shown in FIG. 11.

Because the determination of surface properties may be compute-intensive, it can be important to limit the computation to points (or objects) of interest. It may make little sense to compute curvatures of background objects that are very far from the camera (because the points appear almost identical in both views). Therefore, it can sometimes be important to restrain the computation to objects with significant disparity in the two views. It may also be important to pre-determine which values of pan and tilt in various stereoscopic camera groups produce interesting views. In most applications, there will be pan and tilt angle combinations that point outside the event and might be ignored (for example, a pair of horizontal fisheye cameras will have some views that point skyward—these would probably not be needed for normal viewing of a sporting event).

After surface points of an object have been characterized by many different stereoscopic pairs (or groups of more than two cameras), the results from different pairs normally must be combined. Different view pairs of the object will add points to the object database as the scan and computation progresses. Overlap should generally be eliminated by averaging. For example, if the normal vector at a point is computed to be (1.45,2.67, −0.16) by one stereoscopic pair and (1.39, 2.55, −0.11) by another, the average value of (1.42, 2.61, 0.135) should be used. One problem is to find absolute coordinates in a “world” 3-dimensional space that apply to the same point in the different pairs. This can be done by precise calibration of the camera distances, and knowledge of the differences in pan and tilt angles (and zoom correction) between different views. It can also be done through the use of “candidate” points or known points in the image. Because of ray blockage, there may be points in the 3-dimensional scene that cannot be seen by any camera in total camera group. These points generally must either be ignored or reconstructed by different methods such as interpolation or animation.

Even though this discussion of a derivation of differential surface properties as relied on the work of Devernay and Faugeras in the cited reference, the discussion has been presented to aid in understanding the present invention. Any method of reconstruction a scene in 2- or 3-dimensions is within the scope of the present invention.

2. Point Recombination

In a preferred situation, each 3-dimensional scene point would appear in the images of many of the cameras covering an event. This would allow simple reconstruction. However, for real events such as sporting events, there will most probably be many points that can only be seen by a few cameras (maybe only one), and there will most probably be points that cannot be seen at all (due to ray blockage by other objects). For a typical sporting event, it is therefore desirable to have overhead shots from towers, balloons, etc. since there is less chance of ray blockage from vertical vantage points.

The primary way that a scene point is located in multiple images from different vantage points is by disparity correlation as previously discussed and shown in FIG. 11. For points shot from highly separated cameras, simpler geometric techniques can be used. For example, the same point from two cameras that are widely separated with standard point projection (frustrum) projection matrices can be found by geometric techniques. The key to locating the same point in the two different images in this simplified method is to know 1) the exact locations of the two camera focal points; 2) the exact direction of view and zoom of each camera; and 3) the distance of the scene point from at least one of the cameras (which can be found by the stereoscopic techniques already presented). It is then a simple matter of geometry to match the point using ray tracing or other techniques known in the art.

Alternatively, as stated above, several reference points or “candidate” points can be provided in the field of view for camera groups that can be easily found in each camera image. These can be, for example, particular fiducial marks, or known objects. Simple geometric registration methods can then adjust the coordinates of other points in the image to their correct values. These methods normally use a system of linear equations generated by the method of least squares known in the art.

The technique of ray tracing provides a means of locating points in different images which correspond. With particular types of events like sporting events, direct overhead shots aid the ray tracing problem tremendously. For example, in the case of a football game, a vertical shot can provide almost complete blockage information for horizontal or almost-horizontal ray tracing. A vertical shot with large zoom can also provide raw diffuse surface information such as diffuse color for many points in the scene that will be viewed from much different angles. Additional information such as the location of lighting (or the sun) can also aid in determining the final color property of a surface point viewed from a particular angle (such as viewed from a virtual field position).

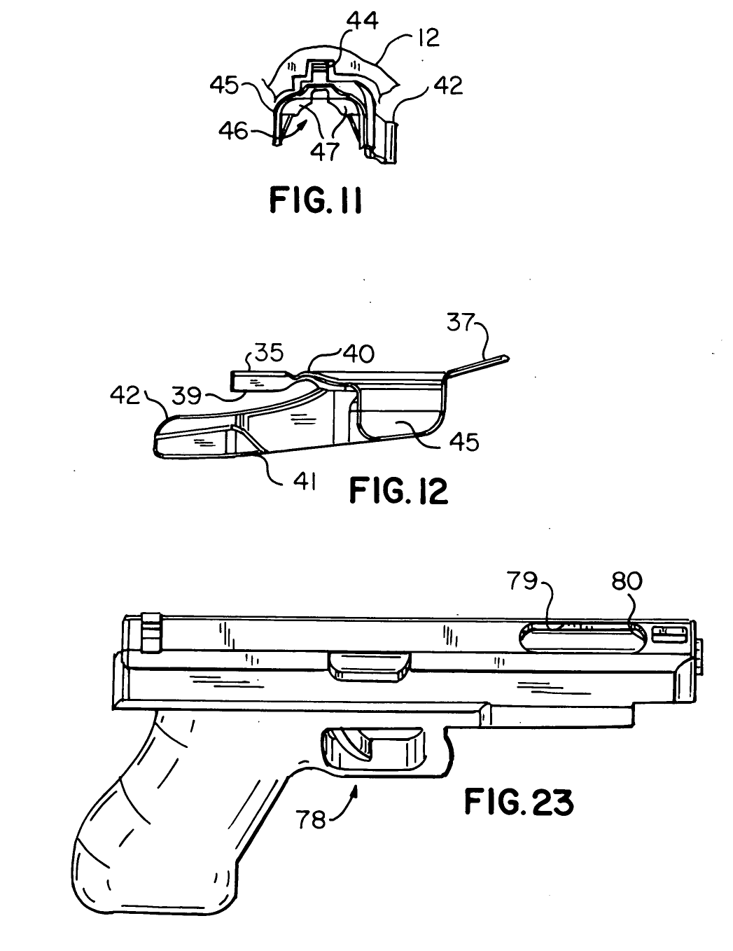

Techniques known in the art such as fuzzy logic and neural networks can also be of aid in point recombination and virtual view synthesis. A embodiment of the logical flow of the input signal processing up to the creation of a 3-dimensional model is shown in FIG. 12. The building blocks of various embodiments of the present invention can be: input sampling, pan/tilt scanning, stereoscopic image reconstruction and 3-dimensional modeling. A time sequence of left and right Lⱼₖₗ and Rⱼₖₗ flat frames exit the input sampling in coded digital form where each point has a set of image coordinates such as λ₁, μ₁ and a color C(λ₁,μ₁). The time frame sampling or output rate should be fast enough to later re-create images as continuous video. The index j indicates time sampling. At each time j, the pan/tilt processor must produce k=1, 2, . . . K images of as much of the scene it can scan (taken from fisheye lenses in the preferred embodiment). The input fisheye images are processed by a Zimmermann processor as previously discussed to produce the flat images. Finally, in the preferred embodiment, the are 1=1, 2 . . . L similar inputs from differently situated camera pairs (in the preferred embodiment, cameras appear in stereoscopic pairs; however, any number of cameras can be used in any polyscopic arrangement). As shown in FIG. 12, the L groups, each of K reconstructs, are fed to a 3-dimensional scene reconstruction processor at time j. This happens for each j resulting in a real-time changing 3-dimensional model of the scene. The real-time sequence of total scenes Sⱼ is fed into a scene storage queue where sample points can be withdrawn for image synthesis.

C. Virtual View Synthesis

When a total 3-dimensional reconstruction of the scene exists, it is a fairly simple matter known in the art to construct a view from any arbitrary camera location (See, e.g., the gluLookAt function in the OpenGl Language—R. Wright, “OpenGl Bible” 3rd Edition, Chapt. 4, SAMS 2004). Mathematically, this operation simply points a perspective matrix P at the field of 3-dimensional points (x,y,z) and projects each point in the projective frustrum onto an image plane at the front of the frustrum. All points outside the frustrum are clipped. As shown in FIG. 12, there can be numerous image synthesis processors, each to process a particular request. This does not necessarily have to be done in parallel if a fast enough processor can be used.

When there are missing points due to incomplete camera coverage or ray blockage, not all arbitrary virtual camera locations are able to produce all points. To solve this problem, the present invention uses several approaches. As stated above, points that are ray blocked can many times be predicted by camera views from above the event. Also, such overviews can also help solve the ray tracing problem. Finally, totally missing points or groups of points can many times be interpolated from nearby points. Also, linear and higher order mini-surfaces can be created to replace missing regions. With the present invention, it is desirable to use as many cameras as possible from as many vantage points as possible to cover an event.

While the preferred method of the present invention is to perform a 3-dimensional reconstruction based on stereoscopic views first, perform ray tracing second, interpolation for small voids third, and animation or surface approximation for large voids fourth, any method or technique or order for creating or approximating a complete or partial 3-dimensional scene in near-real time, or any method of creating arbitrary or predetermined 2- or 3-dimensional virtual images is within the scope of the present invention.

User Interfaces

The user interface is normally a device in possession of the user that 1) enters the image request, and 2) displays the image or images requested. Many types of devices can be used, and the two functions can be split between two different devices such as a handheld image control unit and a cable TV. All or part of the device can be wireless. An example of a partially wireless device is a handheld image request unit used in conjunction with a cable TV that is in wireless or infrared communication with a set-top box that then sends the image request upstream on a cable. An example of a totally wireless system is a cellular telephone that sends out image requests and displays images on its screen. Images can be sent from a distribution center to user interfaces in the form of video, frames, stills, or in any other form. Images can be in color or black and white. Colored video images are preferred. Some lower bandwidth capable devices may wish to optionally sacrifice color for a faster frame rates. 3-dimensional user interfaces are also within the scope of the present invention.

A. Standard User Interfaces

A standard interface may be a television set coupled to a cable modem. Images can be requested from a hand-held remote unit that communicates with the TV set or cable modem by infrared or wireless RF. Image requests can be sent upstream from the cable modem to the distribution center, while continuous video images can be sent downstream in the normal manner using a cable channel. Another standard interface might be a PC that sends image requests through a server on a webpage while receiving streaming video images.

B. Non-Standard Interfaces

The present invention can also include specially constructed user interfaces. A particular interface specially adapted to make image requests and receive custom images is shown in FIG. 13. A folding-up, hand-held unit 10 communicates wirelessly using a transceiver known in the art and an antenna 12. The device in FIG. 13 could wirelessly communicate directly with an image supplier or via a LAN, WAN, point of presence, or other wireless network. A viewing screen 13 capable of displaying color video images can be contained in a housing 14 which can form a folding lid. Various keys 15 can be used to select up images or issue requests or commands from the unit. A mouse or joystick 16 can be used to control pan or tilt for some types of image requests. A control display 11 such as LCD displays known in the art can be used to list the current and/or available images. Selection keys 18 can be used to select pre-computed (canned) images (such as a canned field goal sequence previously described). Requested images can be optionally chosen to be displayed in split-screen. Screen splitting controls 17 can be used to position or change split screen images.

Many types of wireless (or wired) devices are within the scope of the present invention. For example, a cellular telephone can also be used to request and display images. In this scenario, the cellular user could simply dial a telephone number, enter an ID or security code, and request images. The images could be displayed on the cellular screen at a frame rate compatible with the bandwidth of the cellular service. In addition, a cellular telephone could be used as part of the uplink (the part of the communication link requesting images) where the actual images are displayed on a wider bandwidth device such as a cable TV or PC connected into a wider bandwidth downlink. For example, FIG. 17 shows an embodiment of the present invention where a user places image requests from a cellular telephone and receives images on a heads-up display that form part of a pair of eyeglasses or are otherwise presented. 3-dimensional displays include “view-cubes”, holographic displays, displays the require special glasses and any other 2-dimensional or 3-dimensional display.

Image Distribution Center

Preferably, the images of the present invention are distributed to subscribers or others from one or more distribution centers. Normally, at least one of these centers will be co-located near the site of the event being imaged. For example, in the case of a sports stadium, the image distribution center can be located somewhere in the complex. In some cases, co-location is impossible (for example a parade). In these cases, typical radio links known in the art can be set up to convey camera video information from the event to a center or through one or more relay points to a center.

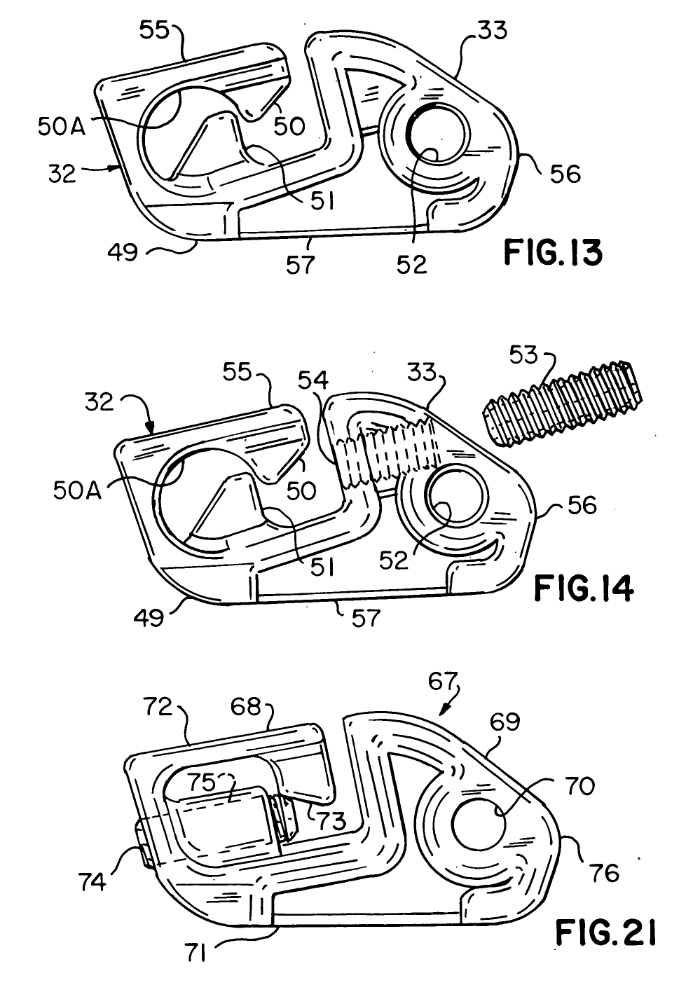

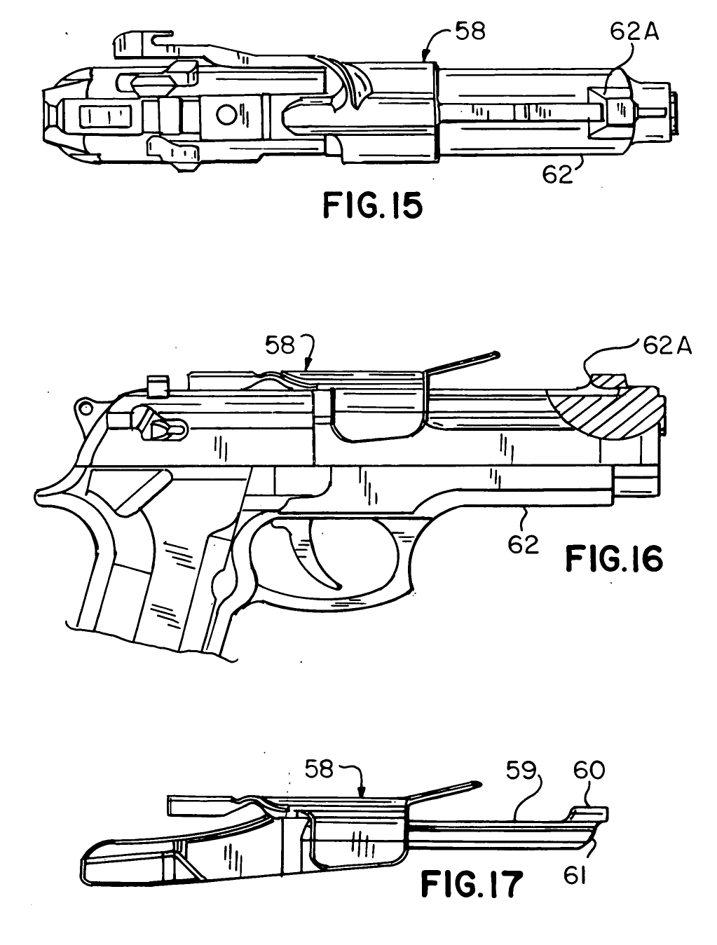

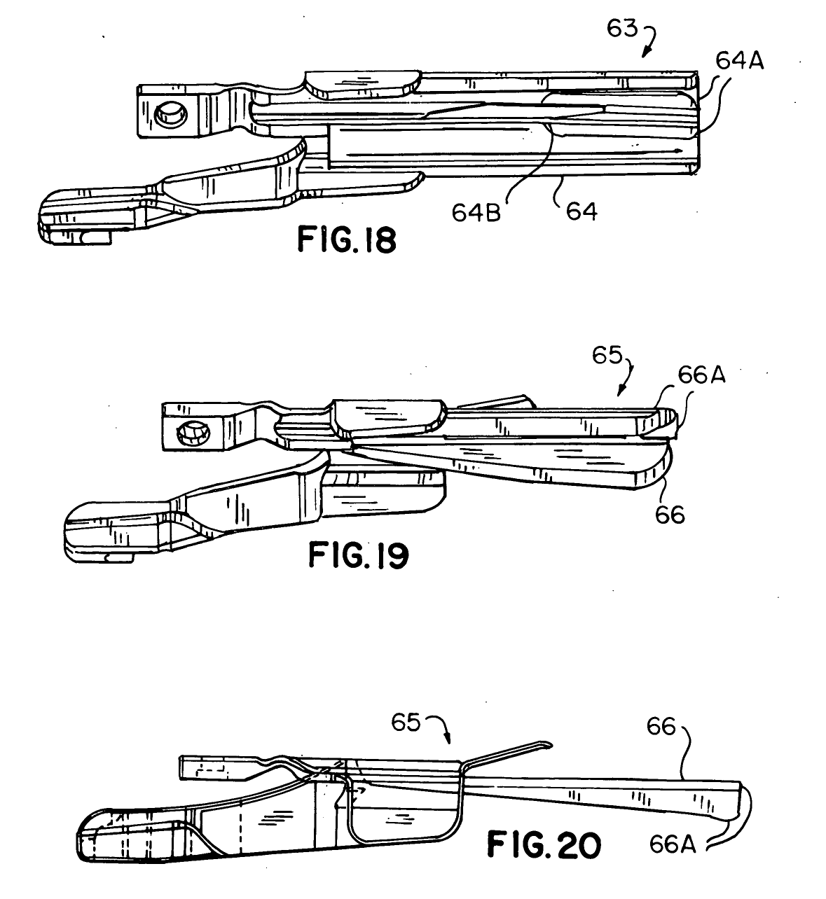

A typical distribution center should be able to provide subscriber hookup, handle image requests, provide billing information for any per-use subscriptions, and of course produce and distribute images to users. To do this, a center must contain several servers and communication interfaces as shown in FIG. 14.

A telephone company interface (TELCO) services regular telephone lines (POTS) for incoming calls. Incoming calls can come from standard telephones or cellular telephones. These POTS calls can be used for inquiries (broadcast schedules, etc.), or they can be used to accept active image requests from subscriber viewers. Although not shown in FIG. 14, some limited image output (at a low bandwidth) can be sent to users over POTS lines that are being used by users with cellular telephone screens or other viewing devices.

A distribution center can also contain an internet interface like that shown in FIG. 14. T1 lines, fiber optics, coax, or Gigabyte Ethernet can be bidirectionally serviced.

Both the Telco interface and the Internet interface can route image requests to a client manager and request server. Generally this is a fast server known in the internet art; however, it can be any type of computer, computers or processing device. FIG. 14 also shows a Digital Subscriber Loop (DSL) interface called a DSLAM known in the DSL art managing bidirectional data over DSL ports. While the DSLAM is shown in FIG. 14 for completeness, in many cases this could be located elsewhere (at the Internet Service Provider (ISP), for example).

The Request Server routes raw image requests to a Request Manager. This is a special computing device that controls and queues incoming requests and provides signal processing capabilities for requests. Each incoming request is normally assigned to an image generator that will service that user until a different request is entered. The request manager is normally responsible for build-up and tear-down of image processes and connections between image generators and user links as well as passing request parameters to the image generator after build-up of an image process. In general, a center contains N image generators, and can service M concurrent image requests. Because a particular image generator can usually handle more than one simultaneous image process, M may be greater then N. If the number of incoming requests exceeds the current image generation capacity of the center, a particular incoming request should be either queued or blocked (blocked means refused). When the rate of blocked requests exceeds a predetermined (but adjustable) threshold, the client manager server generally refuses to accept new clients. The operation of the request manager is similar to the service process known in the telephone central/toll office art for point-to-point service.

Once the Request Manager accepts a request for a particular image stream, it creates an image process and assigns resources to it, namely an image generator in the Signal Processing module and an output video or stream path (straight video is usually used with cable clients, and a stream path may be used with internet clients). If the client is “special” in the sense that their bandwidth is restricted (like a cellular telephone), or the client requires some other special treatment, the Request Manager can set up the correct image process for that client (such as sequential fixed frame transmissions or black and white transmissions).

The Signal Processing module which in FIG. 14 includes Scene Storage as well as Image Generators, creates the desired images either from real-time stored 3-dimensional models previously described, from direct camera feeds at a particular pan/tilt/zoom setting, or from a commercial broadcast feed. In particular, the Signal Process module can combine images from any of these sources to produce split-screen and other special images. A manual input to the Signal Processing module shown in FIG. 14 allows particular “canned“image sequences with dynamically changing parameters to be controlled by a human operator or director. An example of this is the field goal kicker's view shown in FIG. 2. To synchronize the camera direction of view and moving location with the kicker's movement and the moment of ball impact, a human normally must steer the scene. The human operator or director can be located on-site or remotely.

The primary inputs to the Signal Processing Module are the feeds from every camera as well as commercial broadcast video. These inputs are handled by a video interface shown in FIG. 14.

Output images leave the Signal Processing Module as streaming video which can be routed to an output server for transport onto the internet or DSL links, as cable video that is transmitted by known techniques to a cable head-end (usually by fiber optics), or as low bandwidth data that can be place on POTS lines. Although not shown in FIG. 14, it is also possible for images to leave by satellite link or any other wireless technique. Any method of transporting output images is within the scope of the present invention.

Signal Processing Hardware System

The Signal Process module shown in FIG. 14 must convert raw video inputs into requested images. The present invention can use any signal processing hardware in any combination or arrangement to process images, create models, handle user requests, and generate user images. In particular, massively parallel computing techniques can be used such as massively parallel digital signal processors (DSPs) or specialized processors. These processors can be off-the-shelf or can be specially designed such as ASICs. Any combination or implementation of signal processing hardware or software is within the scope of the present invention. In general, the signal processing hardware of the present invention implement all signal processing functions required including the functions shown in FIG. 12.

A. Input Scene Processing

Input scene processing requires handling of the video feeds of usually a large number of cameras. Input feeds generally appear in analog form such as RS-170, NTSC, PAN or other video formats including digital. Analog feeds generally need to be digitized and framed into a series of equivalent still images, usually in stereoscopic pairs. FIG. 15 shows a bank of timed A/D converters (A/D Bank) taking input data from cameras normally containing fisheye lenses and feeding a bank of DSPs (DSP Bank2), each running the parallel task of pan/tilt scanning. The raw digitized fisheye data in FIG. 15 are labeled LFⱼ and RFⱼ. The output of the A/D converters can contain separate digital code words for red, green and blue; for composite color video, or preferably be single color codewords for each time sample using a large number of bits (such as 72 bits). The advantage of color words is that all the point color and brightness information is contained in a single word. The color words represent generally orthogonal (or at least spanning) coordinates in a particular color pallet space. Several of these spaces are known in the art. Particular ones are Red/Green/Blue spaces and Yellow/Cyan/Magenta spaces. It is also possible to use the classical gamma/I/Q space from color television. A particular advantage of a gamma/I/Q space is that it is simple to separate out a black and white image (simply the gamma component), and the Q color component can be down-sampled in time (because of its reduced bandwidth). The preferred method is to use a Red/Green/Blue space with possible under-sampling or decimation on red. Any color space representation or method of representing the color and/or brightness of a point are within the scope of the present invention.

The DSPs in Bank 1 of FIG. 15 can produce a sequence of images Lⱼₖ Rⱼₖ for k=1, 2, 3, . . . K, each image coming from jth digitized fisheye frame, where j=1, 2, 3 . . . and represents time. The (j,k) image pair can represent a pair of stereoscopic images as though taken from two fixed cameras located a calibrated distance apart at a discrete scene time of j. All of the images with index j represent the same time in the frozen real-time scene. The index k represents different sets of overlapping pairs of images. The totality of K sets, covers the entire scene visible from a particular camera pair (note: a third index 1 could be assigned to represent a particular camera pair—in that case a single image pair would be Lᵢₖ₁ and Rⱼₖₗ). The indices k and 1 (if it is used), are finite; the index j represents time and runs continuously.

B. Model Building

In a typical system, a number of image pairs based on the two or three indices i, j, and k can be fed to banks of stereoscopic reconstruction processors (DSP Bank 3 in FIG. 15). Each reconstruction processor tries to reconstruct a part of the 3-dimensional scene using the techniques previously described to find the coordinates of scene points, normal vectors, curvatures, disparity maps, disparity confidence maps, point surface color, possibly point surface texture, and point highlight information (if specular reflections are included in the computations).

FIG. 15 also shows further processing that attempts to perform and store the real-time total scene model Sⱼ at time j. The total scene model results from the statistical recombination of all the partial data supplied from the individual stereoscopic processors. These tasks are performed by DSP Bank 3 in FIG. 15. Artificial intelligence techniques, fuzzy logic, neural networks and any other processing or learning methods can be used to create a total 3-dimensional model at time j of as much of the scene as possible. At this stage, logical interpolation is usually necessary to produce the entire scene (to cover holes and places where there is incomplete data). Techniques known in the art such as surface patches, straight interpolation, animation and other techniques can be used for this purpose.

The output of the total image processing hardware is a series of 3-dimensional models in real-time . . . Sⱼ₋₁, Sⱼ, Sⱼ₊₁, . . . that can be queued or stored in a scene storage module which normally is a RAM queue or FIFO memory bank that can quickly transfer in, temporarily store, and transfer out large amounts of data. In hardware, this is typically done with numerous parallel paths and parallel RAM or other storage devices.

C. Image Generation Processing

Image generation again is a parallel task in the preferred embodiment of the present invention with numerous processors as shown in FIG. 15 as DSP Bank 4 with each processor dedicated to producing a particular image stream . . . Qⱼ₋₁, Qⱼ, Qⱼ₊₁ . . . of flat 2-dimensional, color output frames that can be read out in serial or parallel fashion as a video stream or otherwise through video converters or other output devices. Each image processor is concerned with producing an image using techniques known in the art from a particular camera location, with a particular direction of view, up direction and magnification (zoom)(a particular projection matrix).

An important part of image generation is the handling and routing of image requests to processors. This can be handled by a request management module and image control processor such as that shown in FIG. 15 that assigns image requests to processors, frees up processors whose image requests have changed and supplies parameters for the desired image to the proper processor. Since some image requests are (slow) functions of time (such as a request for a slow pan or zoom), the management module must keep track of the time progress of such a request and feed the particular parameters to the processor producing the desired image. An example of this is the moving scene from the field goal kicker's eyes. This is first a frozen scene. When the ball is snapped, the kicker begins to run toward the ball. This is a continuous zoom with a tilt keeping the direction of view on the ball. Finally after the ball is kicked the zoom can stop or slow, and the tilt must move up to look at the goal posts. Once this sequence is finished (with the field goal either being made or missed), the image request can be killed by the management module and the DSP image processor released.

Request Management

A feature of the present invention is the ability of user/viewers to request and receive special real-time, color, video or moving images of events. This feature is augmented by providing certain predetermined or “canned” special image parameters. This makes it easier for the user to control what is being watched without losing the scene by accidentally mis-specifying view parameters. One embodiment of this feature is that a standard view of the event (such as standard broadcast video) can always be presented along with special images (at least on devices with large enough displays to permit split screens). The system cannot generally determine if a request for a special image is what the viewer intended or not. For example, the system may receive a request for a view of the crowd rather than the event (or event the sky). Usually, this is a mistake where the user directed the request incorrectly. However, there is the possibility the user really does want to scan the crowd or look at the Goodyear Blimp. Therefore, such requests must, in general, be honored. The present invention attempts to provide user friendliness two ways in such a situation: 1) provide the “strange” view in a sub-window (split screen) with at least one normal view still appearing somewhere on the screen, and 2) provide a single button or stroke method to kill an errant request and return to the previous state. If the user really wants full screen coverage of the requested “strange” view rather than split screen, this can be accomplished by a simple override command.

It has been discovered by users of graphics presentation programs such as OpenGl that pointing the camera at something by providing coordinates or vectors is very difficult even for an experienced user (many times a tiny vector mistake causes the camera to see only the ground or sky, etc. or point in some strange, undesired direction). The present invention overcomes this difficulty several ways. A first way is to always have a “good” view available that the user can start at and easily return to. The second way is to allow the user to “drive” the view from the known good starting point to the final view with the use of a joystick, mouse, or similar device. Coordinate or vector entry can be allowed, but only as a secondary method of specifying views. “Driving” a view from a know good image to a final vantage point usually requires a progressive sequence of requests to be sent from the user's command device to the system. The preferred method for this is to produce a smooth transition from each request to the next, so that the user experiences a smooth pan, tilt, zoom or translation. This type of sequencing of requests can be produced by special command devices provided by the image service, or they can be approximated from simpler devices such as cell phones by using any signaling method including touch tones.

In addition to totally user controlled image requests, the present invention also can provide predetermined fixed vantage points that can remain fixed or change throughout an event (either automatically or under operator/director control). These can be button selectable by the user. In addition, the present invention can provide specific situation based dynamic images. The example shown in FIG. 2 of the view from the field goal kicker's eyes is an example of this. Other examples could be the view from the runner's eyes, the view from a float in a parade (rather than just looking at the float), the view from a high jumper's eyes, the moving view from a kicked ball (looking down and forward) during a kickoff, the batter's or catcher's view, etc. In general, any fixed or moving view is within the scope of the present invention.

The present invention also allows custom instant replays. After a big play, the user can elect to re-view it from different angles. Such image sequences could be saved by the user for later replay in some embodiments. A special subscription service could allow a user to order up a replay of a particular play (with the entire scene sequence saved by the provider in 3-dimensions). The user could then replay the sub-event over and over examining it from different views and angles.

Content Production

Another application of the present invention is in the field of content production such as that used to produce television programs and motion pictures. For example, scenes could be filmed with multiple cameras at several locations around the scene. Custom images could then be produced by a director from various locations, angles and directions of view. The multi-camera system of the present invention could replace the use of a single camera that is moved from point to point and repositioned for each scene. Where multiple cameras are used to capture two or more actors in a given scene, the director/producer could assemble custom images as needed for production of the final version. This could lead to the production of several “final” versions. This would allow the director to select a multitude of custom images from many positions and angles at the same time from a single capture sequence. This would be a significant improvement over current methods with a savings in time and production budget. The custom image, multi-camera method of the present invention also enables a director to produce an interactive version of a production where various custom images are selectable by viewers from content that has been stored in media format such as DVD or a storage network for streaming. The present invention could be used to create re-runs of films that actually contain different images from different angles than the original. The present invention can also be used to produce enhanced training videos or films where the user can stop the action and replay it with from a different angle or zoom. This would be very useful for leaning a process or technique.

An other example of the applicability of the present invention is the filming of a social event such as a wedding or reception where viewers later could produce a variety of custom images of the event or of individuals attending the event. Several fisheye or wide-angle cameras positioned above and around the event could provide enough data for later quality custom image production.

In addition to real-time viewing of events like parades and sporting events, the present invention provides a method where custom images selected by a viewer could be transferred to a 3-dimensional image display for viewing in a full three dimensions. Such devices could be holographic or any other type of 3-dimensional display or viewer (an example might be a “view-cube”). Viewers could optionally wear special glasses to facilitate the reconstruction of 3-dimensional images. Large format 3-dimensional display of custom images could be selected by an event director or could be presented in the temporal sequence of the event. Thus viewers attending an event such as a sporting event could view true 3-dimensional images on a large display located in the arena or stadium or projected on a building or on an integrated display such as the large billboards seen in Times Square New York. Cellular subscribers could utilize specialized wearable displays such as-heads-up displays that either directly provide 2-dimensional or 3-dimensional custom images or alternatively are synchronized with a signal that enables the wearable display to produce information that is perceived by the viewing subscriber to experience. For example, the signal may present alternative imaging to the left and right eyes to produce a 3-dimensional image using a stereoscopic projection. The cellular subscriber could select not only direct viewing of custom images of an event, but could also direct the transmission and storage of custom images to an alternative device or storage media for subsequent viewing or production. Additional audio information could be simultaneously stored.

A first viewer such as an event director may select one or more custom images from the multi-camera system of the present invention for presentation to one or more additional viewers in either a 2-dimensional or 3-dimensional representation. The event director could establish a temporal sequence of custom image selections that are synchronously or asynchronously related to the specific event. Thus, the event director or a first viewer could provide custom images from an on-going or current event or a previously recorded event such as an advertisement for a product or service, a movie or a live event like a parade or sporting event.

A previously recorded event could also include custom image content that a first or subsequent viewer can selectively browse and make specific selection for obtaining at least one custom image in either 2-dimensional or 3-dimensional representation by using either a user interface on a receiving device such as a key pad or a voice input system such as intelligent voice response or speech recognition to complete a selection. The selection of custom images from specific sequences of stored or broadcast content by a first or subsequent viewer can be facilitated by embedding a digital water mark in the content that can be recognized by the viewing device to facilitate the selection of at least one custom image by the first or subsequent viewer. Thus, a viewer my be alerted when custom images are available from specific transmitted or stored content either by a visual signal or cue that could be displayed, by an audio alert, or by the automatic recognition of a watermark or digital mark by the viewer's receiver.

Security Applications

Although the present invention finds utility in entertainment, film making and the like, it is also very useful in security, battlefield and intelligence gathering applications.

Subscription Service and Business Method

The present invention can supply custom images as a subscription service where users pay a use fee or a periodic subscription fee. Partial support for the service could be provided by advertisements. FIG. 16 shows a block diagram of a business model for the present invention. On the left are costs represented by maintenance, equipment, personnel, costs for communications channels, costs for broadcast rights, physical space, insurance and other possible costs. On the right are revenues represented by sold advertising, subscriptions, special premiums charged for special broadcasts (like the Superbowl), one-time use fees paid by a consumer for a special event, per image fees, and revenues from the sale of special image receiving and presentation equipment. The difference, as shown in FIG. 16, is a profit.

Of particular interest in the business model of the present invention are subscriptions, and special fees. Users can subscribe to a basic service that provides them with custom images for special events (or whenever custom images are broadcasted or available). This allows the user access any time the service is available. For the business model, subscriptions provide a continuous revenue stream. Special premiums could be charged for very important events.

A different class of users could pay one-time charges for a particular event. Advertising and promotion could get them to subscribe later. Per-image fees can be charged for each time a user asks for a different generated image; however, most users prefer to pay for a period where they could choose any image they wanted. In this case, subscriptions or one-time use billing may lead to more total revenue.

While some aspects of a business model have been presented, any method of making a profit by providing custom images of a scene or event is within the scope of the present invention. Embodiments of the present invention allow a user to demand any virtual image possible in or around an event or any real pan, tilt or zoom of any camera covering the event, or simply demand views from different broadcast cameras that currently exist (where pan, tilt and/or zoom can be controlled by the broadcaster as in current TV event coverage). In such an embodiment, the user could simply be his or her own director selecting which camera to current watch from. Multiple views from different broadcast cameras could be simultaneously fed to the user for a split screen presentation. This could be changed by user demand.

Several descriptions, examples and illustrations have been presented to better aid in understanding the present invention. One skilled in the art will understand that many changes and variations are possible. All of these changes and variations are within the scope of the present invention.

We claim:

1. A system for supplying custom images of an event, said system comprising:
at least one camera positioned at or proximate an event, the camera receiving images from the event and producing image data;
a processor in communication with the camera for receiving image data from the camera, the processor also being in communication with a plurality of viewers for receiving custom image demands from the viewers, the custom image demands including parameters for the custom images;
the processor producing different custom images for different viewers according to the parameters of the custom image demands.

2. The system of claim 1 further comprising a plurality of cameras.

3. The system of claim 2, wherein one of the cameras is positioned in stereoscopic relationship to one of the other cameras.

4. The system of claim 1, wherein one of the parameters includes a virtual camera location for providing a desired direction of view.

5. A system for supplying custom images of an event, said system comprising:
camera means for receiving images from the event and producing image data;
processor means for receiving image data from the camera means, receiving custom image demands with parameters from a plurality of viewers, and producing different custom images for different viewers according to the parameters;
first connection means for connection the camera means with the processor means;
second connection means for connecting the processor means to the plurality of viewers.

6. The system of claim 5, wherein the camera means includes a video camera.

7. The system of claim 6, wherein the camera means includes a plurality of cameras.

8. The system of claim 7, wherein one of the cameras is positioned in stereoscopic relationship to one of the other cameras.

9. The system of claim 5, wherein one of the parameters includes a virtual camera location for producing a desired direction of view.

10. The system of claim 5, wherein the second connection means is a communication network.

11. The system of claim 10, wherein the communication network is wireless.

12. The system of claim 5, wherein the first connection means is a communication network.

13. The system of claim 12, wherein the communication network is wireless.

14. A method of supplying custom images of an event to a plurality of users on demand, the method comprising the steps of:
producing image signals from images obtained at or proximate the event;
accepting the image signals and different image demands from different users, the image demands including parameters-for the desired custom images;
processing the image signals according to the image demands of the plurality of the users; and
transmitting different custom images to different users.

15. The method of claim 14, wherein the image signals are produced by one or more cameras.

16. The method of claim 14, wherein the parameters contain at least one virtual camera location.

17. The method of claim 14, wherein the different custom images are transmitted to different users simultaneously.

18. The method of claim 14, wherein the demands are accepted and the custom images are transmitted via a wireless network.

19. The method of claim 14, wherein the demands are accepted and the custom images are transmitted via the internet.

20. The method of claim 14, wherein the image signals are accepted via a wireless network.
